(19) United States
(12) Patent Application Publication
(10) Pub. No.: US 2022/0143916 A1
(43) Pub. Date: May 12, 2022

(54) DEFINED LABELS FOR 3D OBJECT MODEL LABEL PLACEHOLDERS

(71) Applicant: Hewlett-Packard Development Company, L.P., Spring, TX (US)

(72) Inventors: Barret Kammerzell, Vancouver, WA (US); Matthew A. Shepherd, Vancouver, WA (US); Pierre J. Kaiser, Vancouver, WA (US)

(73) Assignee: Hewlett-Packard Development Company, L.P., Spring, TX (US)

(21) Appl. No.: 17/418,786

(22) PCT Filed: Jul. 31, 2019
(86) PCT No.: PCT/US2019/044521

§ 371 Date: Jun. 26, 2021

(51) Int. Cl. B29C 64/386; B33Y 50/00; B22F 10/80; G05B 19/4099

(52) U.S. Cl. CPC B29C 64/386; B33Y 50/00; G05B 2219/35134; G05B 19/4099; B22F 10/80

(57) ABSTRACT

According to examples, an apparatus may include a processor and a memory on which are stored machine-readable instructions that when executed by the processor, may cause the processor to access data corresponding to a 3D object model, in which the data may identify a label placeholder on the 3D object model. The processor may also access fabrication information pertaining to a 3D object to be fabricated based on the data, generate a defined label based on the accessed fabrication information, and may insert the defined label at the label placeholder on the 3D object model, such that the 3D object may be fabricated with the defined label positioned at a location on the 3D object corresponding to the label placeholder on the 3D object model.

### BACKGROUND

In three-dimensional (3D) printing, an additive printing process may be used to make 3D solid parts from a digital model. Some 3D printing techniques are considered additive processes because they involve the application of successive layers or volumes of a build material, such as a powder or powder-like build material, to an existing surface (or previous layer). 3D printing often includes solidification of the build material, which for some materials may be accomplished through use of heat, a chemical binder, and/or an ultra-violet or a heat curable binder.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may insert a defined label at a label placeholder on a 3D object model;

FIG. 2 shows a diagram of an example system in which the apparatus depicted in FIG. 1 and a 3D fabrication device may be implemented;

FIG. 3 shows a flow diagram of an example method for modifying a print file 250 to insert a defined label at a label placeholder; and

FIG. 4 shows a block diagram of an example system that may include the apparatus depicted in FIG. 1 and the 3D fabrication device 210 depicted in FIG. 2.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are apparatuses, methods, and systems for inserting, by a 3D fabrication device or by a pre-processing application on an apparatus, a defined label at a label placeholder on a 3D object model, in which the defined label is to be fabricated with a 3D object based on the 3D object model. In some examples, a designer and/or programmer of the 3D object model may have included the features of the label placeholder on the 3D object model to define the location at which the defined label is to be positioned on the 3D object. In one regard, by defining the location of the defined label, fabrication of the defined label at an undesirable and/or non-functional location on the 3D object may be limited and/or avoided.

As also disclosed herein, a processor may access data corresponding to the 3D object model, in which the data may identify the label placeholder. That is, the data may identify features of the label placeholder, such as a location, a size, a color, and/or the like. In addition, the processor may access fabrication information pertaining to the 3D object that is to be fabricated based on the data. The fabrication information may include, for instance, information pertaining to a physical position and/or orientation of the 3D object with respect to a build chamber, information pertaining build material particles used for fabricate the 3D object, information pertaining to a 3D fabrication device that is to fabricate the 3D object, and/or the like. The fabrication information may change for different build operations of 3D objects based on the 3D object models. As such, for instance, the defined labels may be dynamic in that the contents of the defined labels may change for different build operations.

In addition, the processor may generate a defined label based on the accessed fabrication information. The processor may also insert the defined label at the label placeholder on the 3D object model such that the 3D object corresponding to the 3D object model may be fabricated with the defined label positioned at a location on the 3D object corresponding to the label placeholder on the 3D object model.

Through implementation of the present disclosure, defined labels may be inserted in place of label placeholders on 3D object models. The defined labels may also be printed or otherwise fabricated on 3D objects corresponding to the 3D object models such that, for instance, fabrication information pertaining to the 3D objects may be identified from the defined labels. In addition, the content in the defined labels may be changed according to different build operations, but the locations of the defined labels may still correspond to the locations of respective label placeholders.

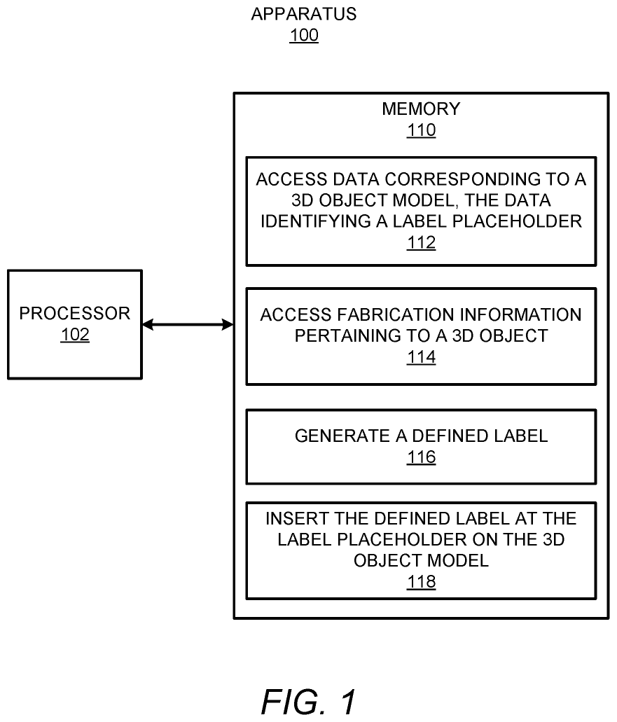

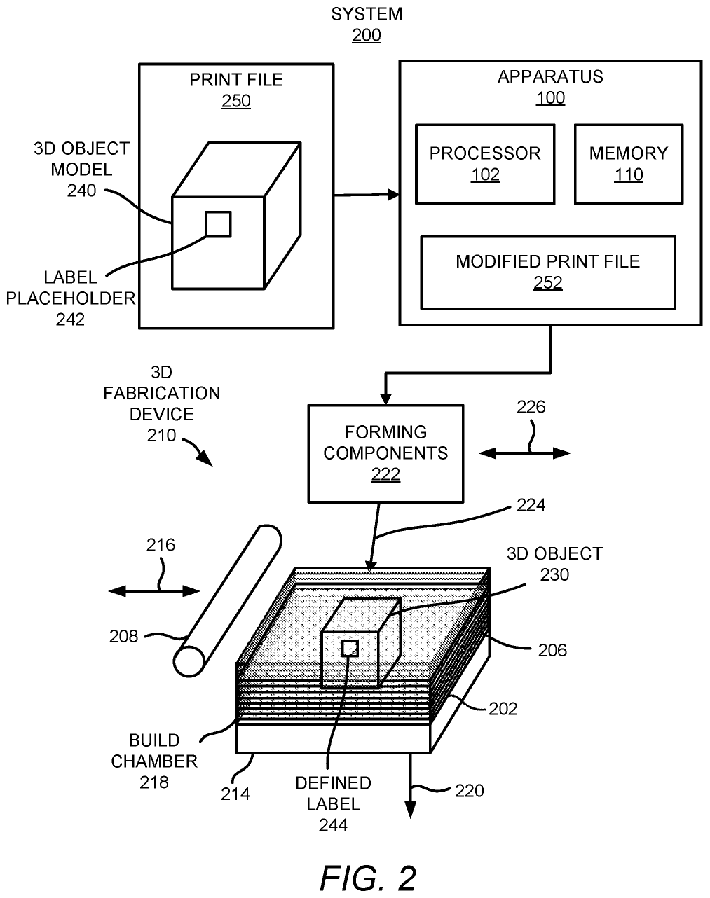

Reference is first made to FIGS. 1 and 2. FIG. 1 shows a block diagram of an example apparatus 100 that may insert a defined label at a label placeholder on a 3D object model. FIG. 2 shows a diagram of an example system 200 in which the apparatus 100 depicted in FIG. 1 and a 3D fabrication device 210 may be implemented. It should be understood that the example apparatus 100 depicted in FIG. 1 and/or the example system 200 depicted in FIG. 2 may include additional features and that some of the features described herein may be removed and/or modified without departing from the scopes of the apparatus 100 and/or the system 200.

The apparatus 100 may be a computing device, a tablet computer, a server computer, a smartphone, or the like. The apparatus 100 may also be part of the 3D fabrication device 210, e.g., may be a control system of the 3D fabrication device 210. Although a single processor 102 is depicted, it should be understood that the apparatus 100 may include multiple processors, multiple cores, or the like, without departing from a scope of the apparatus 100.

The 3D fabrication device 210, which may also be termed a 3D printing system, a 3D fabricator, or the like, may be implemented to fabricate 3D objects through selective binding and/or solidifying of build material particles 202, which may also be termed particles 202 of build material, together. In some examples, the 3D fabrication device 210 may use energy, e.g., in the form of light and/or heat, to selectively fuse the particles 202. In addition or in other examples, the 3D fabrication device 210 may use fusing and/or binding agents to selectively bind or solidify the particles 202. In particular examples, the 3D fabrication device 210 may use a chemical binder, a thermally curable binder, and/or the like. In other particular examples, the 3D fabrication device 210 may use fusing agents that increase the absorption of energy to selectively fuse the particles 202.

According to one example, a suitable fusing agent may be an ink-type formulation including carbon black, such as, for example, the fusing agent formulation commercially known as V1Q60A “HP fusing agent” available from HP Inc. In one example, such a fusing agent may additionally include an infra-red light absorber. In one example such fusing agent may additionally include a near infra-red light absorber. In one example, such a fusing agent may additionally include a visible light absorber. In one example, such a fusing agent may additionally include a UV light absorber. Examples of fusing agents including visible light enhancers are dye based colored ink and pigment based colored ink, such as inks commercially known as CE039A and CE042A available from HP Inc. According to one example, the 3D fabrication device 210 may additionally use a detailing agent. According to one example, a suitable detailing agent may be a formulation commercially known as V1Q61A “HP detailing agent” available from HP Inc.

The build material particles 202 may include any suitable material for use in forming 3D objects. The build material particles 202 may include, for instance, a polymer, a plastic, a ceramic, a nylon, a metal, combinations thereof, or the like, and may be in the form of a powder or a powder-like material. Additionally, the build material particles 202 may be formed to have dimensions, e.g., widths, diameters, or the like, that are generally between about 5 μm and about 100 μm. In other examples, the particles may have dimensions that are generally between about 30 μm and about 60 μm. The particles may have any of multiple shapes, for instance, as a result of larger particles being ground into smaller particles. In some examples, the particles may be formed from, or may include, short fibers that may, for example, have been cut into short lengths from long strands or threads of material. In addition or in other examples, the particles may be partially transparent or opaque. According to one example, a suitable build material may be PA12 build material commercially known as V1R10A “HP PA12” available from HP Inc.

As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. The apparatus 100 may also include a memory 110 that may have stored thereon machine-readable instructions 112-118 (which may also be termed computer readable instructions) that the processor 102 may execute. The memory 110 may be an electronic, magnetic, optical, or other physical storage device that contains or stores executable instructions. The memory 110 may be, for example, Random Access memory (RAM), an Electrically Erasable Programmable Read-Only Memory (EEPROM), a storage device, an optical disc, and the like. The memory 110, which may also be referred to as a computer readable storage medium, may be a non-transitory machine-readable storage medium, where the term “non-transitory” does not encompass transitory propagating signals.

The 3D fabrication device 210 may include a spreader 212 (e.g., a roller) that may spread or otherwise form the build material particles 202 into a layer 206 (also referred to herein as a “build layer”), e.g., through movement across a platform 214 as indicated by the arrow 216. The 3D fabrication device 210 may also include a build chamber 218 within which the spreader 212 may spread the build material particles 202 in multiple layers 206 as the platform 214 is moved in a downward direction as indicated by the arrow 220. In this regard, the platform 214 may be moved within the build chamber 218. The walls of the build chamber 218 are not shown such that the interior of the build chamber 218 may be readily visible.

The 3D fabrication device 210 may also include forming components 222 that may output energy and/or an agent 224 onto the layer 206 as the forming components 222 are scanned across the layer 206 as denoted by the arrow 226. The forming components 222 may also be scanned in the direction perpendicular to the arrow 226 or in other directions. In addition, or alternatively, the platform 214 on which the layers 206 are deposited may be scanned in various directions with respect to the forming components 222. The forming components 222 may include, for instance, an energy source, e.g., a laser beam source, a heating lamp, or the like, that may apply energy across the layer 206 and/or in selected areas of the layer 206. In addition or alternatively, the forming components 222 may include an agent delivery device to selectively deliver an agent 224 or multiple agents 224 onto the build material particles 202 in the layer 206. The agent(s) 224 may include any of the agents, e.g., fusing agents, binder agents, etc., discussed herein. In some examples, the agent(s) 224 may be applied to the build material particles 202 prior to application of energy onto the build material particles 202.

In any of the examples discussed herein, the forming components 222 may cause the build material particles 202 in the layer 206 to be selectively bound and/or solidified to form a portion of a 3D object 230. In addition, the build material 202 in multiple layers 206 may selectively be bound and/or solidified to form additional portions of the 3D object 230 within the build chamber 218, until the 3D object 230 is formed.

As discussed herein, the 3D object 230 may be fabricated based on or, similarly, according to, data corresponding to a 3D object model 240. The data may include data that describes features, e.g., dimensions, colors, textures, displacements, and/or the like, of the 3D object model 240. For instance, the data may include a diffuse color map for the 3D object model 240 that may identify colors that surfaces of the 3D object model 240 have and thus, the colors that the surfaces of the 3D object 230 to be fabricated based on the 3D object model 240 are to have. The data may also include a displacement map for the 3D object model 240 that may identify offset features that the surfaces of the 3D object model 240 have and thus, the offset features, e.g., physical dimensions, that the surfaces of the 3D object 230 to be fabricated based on the 3D object model 240 are to have. In some examples, a print file 250 may include or may be equivalent to the data corresponding to the 3D object model 240.

According to examples, the data, e.g., in the print file 250 or the print file 250 itself, may also identify a label placeholder 242 on the 3D object model 240. Particularly, the data may identify features of the label placeholder 242 such as, dimensions, a particular surface of the 3D object model 240, a position on a particular surface of the 3D object model 240, content in the label placeholder 242 (which may include text, symbols, color, etc.), and/or the like, of the label placeholder 242. The label placeholder 242 may be a placeholder for a defined label 244 that is to be fabricated on the 3D object 230 based on the data related to the 3D object 230. In other words, the label placeholder 242 may define features such as location, size, and/or the like, at which the defined label 244 is to be fabricated on the 3D object 230. As such, for instance, the label placeholder 242 may define the size, shape, and/or location on the 3D object model 240 that a corresponding defined label 244 is to have on the 3D object 230.

The label placeholder 242 may have visually distinguishing features from the other sections of the 3D object model 240 such that the processor 102 and/or a user may locate the label placeholder 242 on the 3D object model 240. For instance, the label placeholder 242 may have a particular color, may include a code, and/or the like.

As discussed herein, the defined label 244 may be generated based on fabrication information pertaining to the 3D object 230 and may be fabricated at a location on the 3D object 230 corresponding to the location of the label placeholder 242 on the 3D object model 240. The fabrication information pertaining to the 3D object 230 may include, for instance, a spatial position (e.g., X, Y, and Z coordinates) within the build chamber 218 at which the 3D object 230 is to be fabricated, an orientation that the 3D object 230 is to have within the build chamber 218 during fabrication of the 3D object 230, the layers 206 of build material particles 202 within which portions of the 3D object 230 are to be fabricated, and/or the like.

The fabrication information may also or alternatively include an identification of the build material particles 202 to be used to fabricate the 3D object 230, such as a type of the build material particles 202, a lot number of the build material particles 202, a composition of the build material particles 202 (e.g., percentage of recycled to fresh powder in the build material particles 202), environmental properties of the build material particles 202 (e.g., current temperature, moisture content, etc.), and/or the like. The fabrication information may further or alternatively include an identification of a 3D fabrication system that is to fabricate the 3D object 230 (e.g., a serial number or other identifier of the 3D fabrication system), a location of the 3D fabrication system that is to fabricate the 3D object 230, a type of the 3D fabrication system that is to fabricate the 3D object 230, and/or the like. The fabrication information may also or alternatively include other types of information such as a name of the 3D object 230, a date on which the 3D object 230 is fabricated, a time at which the 3D object 230 is fabricated, and/or the like.

According to examples, the fabrication information may be included in human readable form on the defined label 244. For instance, the defined label 244 may include text and/or symbols corresponding to the fabrication information. In addition or in other examples, the fabrication information may be included in machine readable form on the defined label 244. For instance, the fabrication information may be converted into a machine-readable format, e.g., a quick response (QR) code, a 2D barcode, a 1D barcode, or the like, and the converted information, e.g., code, may be included in the defined label 244. In any regard, the 3D object 230 may be fabricated to include the defined label 244 at a location on the 3D object 230 that may correspond to the location of the label placeholder 242 on the 3D object model 240.

In some examples, a designer and/or programmer of the 3D object model 240 may have included the features of the label placeholder 242 on the 3D object model 240 in the print file 250. In one regard, therefore, the designer and/or programmer may define the location at which the defined label 244 is to be positioned on the 3D object 230 such that, for instance, fabrication of the defined label 244 at an undesirable and/or non-functional location on the 3D object 230 may be limited and/or avoided. In addition, the designer and/or programmer may to designate a zone on the 3D object 230 where it is acceptable to have label information added during fabrication of the 3D object 230. In other examples, however, the processor 102 may determine the location of the label placeholder 242 on a surface of the 3D object model 240.

In addition or alternatively, the label placeholder 242 may define a type of information to be included in the defined label 244. In this regard, a designer and/or programmer may include information in the label placeholder 242 that may indicate the type of information to be included in the defined label 244. By way of particular example, the label placeholder 242 may include a code that may define the type of information, e.g., data pertaining to fabrication, an expiration date of the 3D object 230, or the like. In addition, the label placeholders 242 of different 3D object models 240 may define different types of information.

With reference to FIGS. 1 and 2, the processor 102 may fetch, decode, and execute the machine-readable instructions 112 to access data corresponding to a 3D object model 240, in which the data may identify a label placeholder 242. As discussed herein, the label placeholder 242 may identify a location and features at which a corresponding defined label 244 may be included in the 3D object model 240. In addition, a 3D object 230 may be fabricated to include the defined label 244. As discussed herein, the processor 102 may access a print file 250 that includes or is the data corresponding to the 3D object model 240. The processor 102 may access the print file 250 from a computing device of a designer, developer, and/or programmer of the print file 250, a data store on which the print file 250 is stored, via a network, and/or the like. Additionally, the processor 102 may access the data for the defined label 244 separately from the print file 250.

The processor 102 may fetch, decode, and execute the machine-readable instructions 114 to access fabrication information pertaining to the 3D object 230 that is to be fabricated based on the accessed data corresponding to the 3D object model 240. In some examples, the processor 102 may receive an instruction that may include the fabrication information. For instance, a user may define the fabrication information to be used to generate a defined label 244 and the processor 102 may access the fabrication information from a data store (not shown). In other examples, the instructions 114 may cause the processor 102 to access a certain type of fabrication information from the data store. In any regard, the fabrication information may include any of the types of information pertaining to the 3D object 230, e.g., build operations of the 3D object 230 as well as other types of information, discussed herein.

The processor 102 may fetch, decode, and execute the machine-readable instructions 116 to generate a defined label 244 to include the accessed fabrication information. The processor 102 may generate the defined label 244 to directly include the fabrication information and/or may generate the defined label 244 to include a code associated with the fabrication information as discussed herein. In instances in which the defined label 244 includes a code associated with the fabrication information, the processor 102 may upload the code to a data store. In addition, the processor 102 may upload the fabrication information corresponding to the code such that the code may be used to determine the fabrication information corresponding to the code.

The processor 102 may fetch, decode, and execute the machine-readable instructions 118 to insert the defined label 244 at the label placeholder 242 on the 3D object model 240. That is, the processor 102 may insert the defined label 244 in place of the label placeholder 242, e.g., may replace the label placeholder 242 with the defined label 244. In any regard, the processor 102 may insert the defined label 244 at the label placeholder 242 location such that the 3D object 230 may be fabricated to include the defined label 244 positioned at a location on the 3D object 230 corresponding to the position of the label placeholder 242 on the 3D object model 240. The defined label 244 may also or alternatively have a similar shape and/or size as the label placeholder 242.

In some examples, the processor 102 may modify the print file 250 to generate a modified print file 252, in which the modified print file 252 may include the defined label 244, e.g., instructions and/or code corresponding to the defined label 244. That is, the processor 102 may modify the print file 250 to insert the defined label 244 at the label placeholder 242 on the 3D object model 240. According to examples, the 3D object 230 may be fabricated in multiple layers 206 of build material particles 202 and the print file 250 may include slice data that identifies how portions of the 3D object 230 are to be fabricated in each of the multiple layers 206 of build material particles 202. That is, for instance, the slice data may identify the locations on each of the layers 206 at which the build material particles 202 are to be bound/fused to form the portions of the 3D object 230. The slice data may also identify other attributes at the locations, e.g., colors, textures, etc. In these examples, the processor 102 may modify the slice data to insert the defined label 244 at the label placeholder 242 on the 3D object model 240.

According to examples, the print file 250 may include a diffuse color map for the 3D object model 240 that identifies colors of surfaces of the 3D object model 240 and a displacement map for the 3D object model 240 that identifies offset features of the surfaces of the 3D object model 240. In these examples, the instructions 118 may further cause the processor 102 to modify the diffuse color map and/or the displacement map for the 3D object model 240 to modify the print file 250 to insert the defined label 244 at the label placeholder 242 on the 3D object model 240. That is, the processor 102 may modify the diffuse color map and/or the displacement map for the 3D object model 240 such that the defined label 244 is fabricated, e.g., printed, with the 3D object 230 during fabrication of the 3D object 230.

According to examples, the print file 250 may include data corresponding to a plurality of 3D object models 240, in which the data related to each of the 3D object models 240 may identify a respective label placeholder 242 on the 3D object model 240. In these examples, the processor 102 may, for each of the 3D object models 240, access fabrication information pertaining to the 3D object 230, in which the accessed fabrication information may differ from the accessed fabrication information pertaining to other ones of the 3D objects 230. In addition, the processor 102 may, for each of the 3D object models 240, generate a defined label 244 to include the accessed fabrication information for the 3D object 230 and may cause the generated defined label 244 to be fabricated on the 3D object 230 at a location on the 3D object 230 corresponding to the label placeholder 242 on the 3D object model 240 for the 3D object 230.

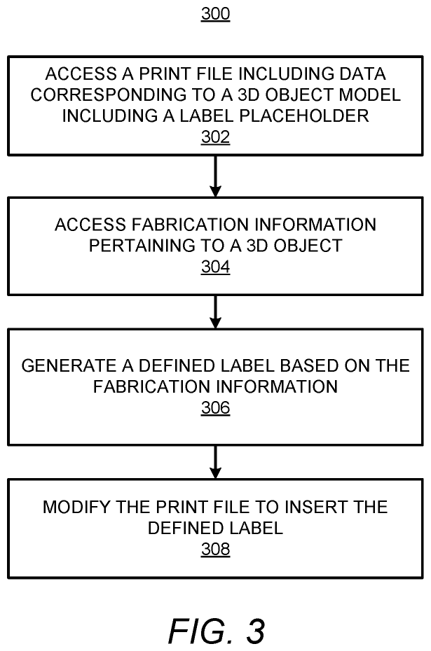

Turning now to FIG. 3, there is shown a flow diagram of an example method 300 for modifying a print file 250 to insert a defined label 244 at a label placeholder 242. It should be understood that the method 300 depicted in FIG. 3 may include additional operations and that some of the operations described therein may be removed and/or modified without departing from the scope of the method 300. The description of the method 300 is also made with reference to the features depicted in FIGS. 1 and 2 for purposes of illustration. Particularly, the processor 102 of the apparatus 100 may execute some or all of the operations included in the method 300.

At block 302, the processor 102 may access a print file 250 that may include data corresponding to a 3D object model 240 in which the data may identify properties of a label placeholder 242 on the 3D object model 240. The properties may include the location, the size, the content, etc., of the label placeholder 242.

At block 304, the processor 102 may access fabrication information pertaining to a build operation of a 3D object 230 to be fabricated based on the data corresponding to the 3D object model 240. The fabrication information may pertain to any of the types of information pertaining to the build operation of the 3D object 230 discussed herein. For instance, the fabrication information may pertain to a build operation of the 3D object 230, such as a spatial position in a build chamber 218 at which the 3D object 230 is to be fabricated, an orientation in the build chamber 218 at which the 3D object 230 is to be fabricated, an identification of a build material from which the 3D object 230 is to be fabricated, a date and/or time at which the 3D object 230 is to be fabricated, and/or a predefined 3D fabrication system that is to fabricate the 3D object 230.

At block 306, the processor 102 may generate a defined label 244 based on the fabrication information. That is, the processor 102 may generate the defined label 244 to include the fabrication information within the dimensions of the label placeholder 242. The processor 102 may generate the defined label 244 to directly include the fabrication information and/or a code corresponding to the fabrication information. In addition, the processor 102 may upload the code and the fabrication information corresponding to the code such that the code may be used to determine the fabrication information corresponding to the code for the 3D object 230 on which the defined label 244 has been fabricated.

At block 308, the processor 102 may modify the print file 250 to insert the defined label 244 at the label placeholder 242. That is, for instance, the processor 102 may generate a modified print file 252 in which the modified print file 252 includes the defined label 244 in place of the label placeholder 242. The processor 102 may modify the print file 250 in any of the manners discussed herein. For instance, the print file 250 may include slice data and the processor 102 may modify the slice data to insert the defined label 244 at the label placeholder 242. As another example, the processor 102 may modify a diffuse color map and/or a displacement map to include the defined label 244 at the label placeholder 242.

Some or all of the operations set forth in the method 300 may be contained as utilities, programs, or subprograms, in any desired computer accessible medium. In addition, the method 300 may be embodied by computer programs, which may exist in a variety of forms. For example, the method 300 may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

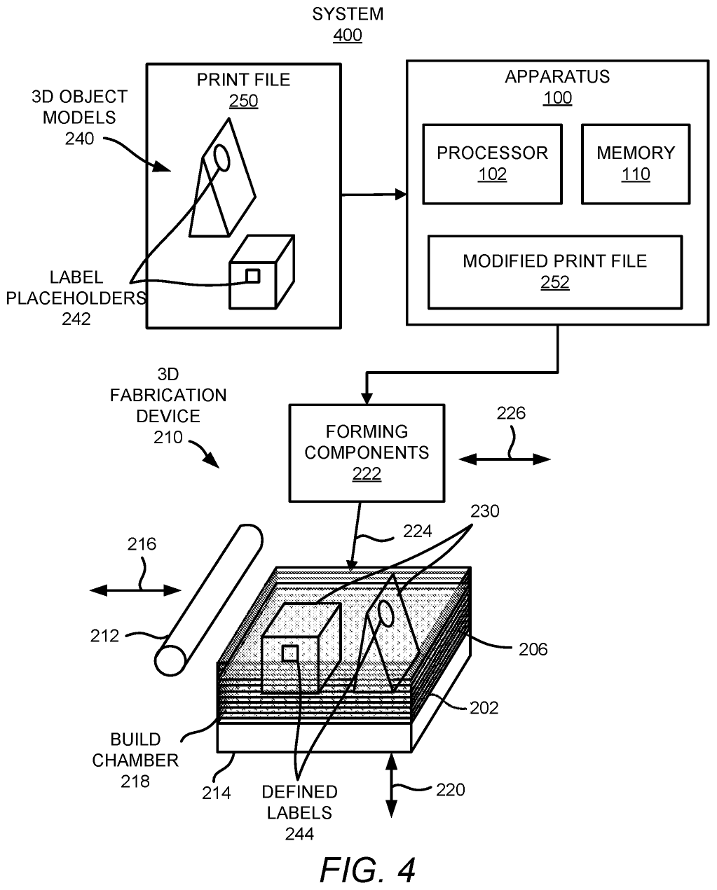

Turning now to FIG. 4, there is shown a block diagram of an example system 400 that may include the apparatus 100 depicted in FIG. 1 and the 3D fabrication device 210 depicted in FIG. 2. As such, the system 400 may include the fabrication components 222 discussed above and the processor 102. The processor 102 may include instructions in the memory 110 and/or may include circuitry that may cause the processor 102 to access a print file 250 that may include data describing a plurality of 3D object models 240, in which the data may be used to fabricate 3D objects 230 corresponding to the plurality of 3D object models 240. The data may also identify properties of label placeholders on the plurality of 3D object models 240.

The processor 102 may also, for each of the plurality of 3D object models 240, access fabrication information pertaining to the 3D object 230, in which the fabrication information for each of the 3D objects 230 may differ from the accessed fabrication information pertaining to other ones of the plurality of 3D objects 230. In other words, the fabrication information for one of the 3D objects 230 may differ from the fabrication information for each of the other ones of the 3D objects 230. The processor 102 may, for each of the 3D object models 240, modify the print file to insert the defined label 244 at the label placeholder 242 of the 3D object model 240. The processor 102 may, for each of the 3D object models 240, generate a defined label 244 based on the accessed fabrication information. In addition, the processor 102 may control the fabrication components 222 to fabricate the plurality of 3D objects 230 to have the respective defined labels 244 using the modified print file 252. This may include control of the spreader 212 to create the layers 206 of build material particles 202 and control of the forming components 222 to selectively bind/fuse the build material particles 202 in each of the layers 206 to form portions of the 3D objects 230 in the layers 206.

As discussed herein, the fabrication information may include, for instance, for each of the 3D object models 240, a spatial position in a build chamber 218 at which the 3D object 230 to be fabricated from the 3D object model 240 is to be fabricated, an orientation in the build chamber 218 at which the 3D object 230 is to be fabricated, a predefined build material from which the 3D object 230, is to be fabricated, a date and/or time at which the 3D object 230 is to be fabricated, and/or a code corresponding to a build operation of the 3D object 230.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium on which is stored instructions that when executed by the processor, are to cause the processor to:
access data corresponding to a three-dimensional (3D) object model, the data identifying a label placeholder on the 3D object model, wherein a 3D object is to be fabricated based on the data;
access fabrication information pertaining to the 3D object;
generate a defined label based on the accessed fabrication information; and
insert the defined label at the label placeholder on the 3D object model, wherein the 3D object is to be fabricated with the defined label positioned at a location on the 3D object corresponding to the label placeholder on the 3D object model.

2. The apparatus of claim 1, wherein the instructions are further to cause the processor to:
access a print file including the data corresponding to the 3D object model; and
modify the print file to insert the defined label at the label placeholder on the 3D object model.

3. The apparatus of claim 2, wherein the 3D object is to be fabricated in multiple layers of build material particles and the print file comprises slice data that identifies how portions of the 3D object are to be fabricated in each of the multiple layers of build material particles, and wherein the instructions are further to cause the processor to modify the slice data to insert the defined label at the label placeholder on the 3D object model.

4. The apparatus of claim 2, wherein the print file includes a diffuse color map for the 3D object model that identifies colors of surfaces of the 3D object model and a displacement map for the 3D object model that identifies offset features of the surfaces of the 3D object model, and wherein the instructions are further to cause the processor to:
modify the diffuse color map and/or the displacement map for the 3D object model to modify the print file to insert the defined label at the label placeholder on the 3D object model.

5. The apparatus of claim 2, wherein the 3D object is to be fabricated in a build chamber, wherein the print file identifies a spatial position and/or an orientation in the build chamber at which the 3D object is to be fabricated, and wherein the accessed fabrication information includes an indication of the identified spatial position and/or orientation in the build chamber at which the 3D object is to be fabricated.

6. The apparatus of claim 1, wherein the 3D object is to be fabricated using a predefined build material by a predefined 3D fabrication system and wherein the accessed fabrication information includes an identification of at least one of:
the predefined build material; and
the predefined 3D fabrication system.

7. The apparatus of claim 1, wherein the instructions are further to cause the processor to generate the defined label to include a code corresponding to the accessed fabrication information and to upload the code to a data store, wherein the code is to be used to determine the accessed fabrication information.

8. The apparatus of claim 1, wherein the instructions are further to cause the processor to:
access data corresponding to a plurality of 3D object models, each of the plurality of 3D object models identifying a respective label placeholder on the 3D object, wherein a respective 3D object is to be fabricated based on the accessed data;
for each of the plurality of 3D object models,
access fabrication information pertaining to the 3D object, wherein the accessed fabrication information differs from the accessed fabrication information pertaining to other ones of the plurality of 3D objects;
generate a defined label to include the accessed fabrication information; and
cause the generated defined label to be fabricated on the 3D object at a location on the 3D object corresponding to the label placeholder on the 3D object model for the 3D object.

9. A method comprising:
accessing, by a processor, a print file including data corresponding to a three-dimensional (3D) object model, the data identifying properties of a label placeholder on the 3D object model;
accessing, by the processor, fabrication information pertaining to a build operation of a 3D object to be fabricated based on the data corresponding to the 3D object model;
generating, by the processor, a defined label based on the accessed fabrication information; and
modifying the print file to insert the defined label at the label placeholder.

10. The method of claim 9, wherein the print file comprises slice data that identifies how portions of the 3D object are to be fabricated in each of multiple layers of build material particles, and wherein the method further comprises:
modifying the slice data to insert the defined label at the label placeholder.

11. The method of claim 9, wherein the print file includes a diffuse color map for the 3D object model that identifies colors of surfaces of the 3D object model and a displacement map for the 3D object model that identifies offset features of the surfaces of the 3D object model, and wherein modifying the print file further comprises:
modifying the diffuse color map and/or the displacement map for the 3D object model to modify the print file to insert the defined label at the label placeholder on the 3D object model.

12. The method of claim 9, wherein accessing the fabrication information pertaining to the build operation of the 3D object further comprises:
accessing fabrication information that includes:
a spatial position in a build chamber at which the 3D object is to be fabricated;
an orientation in the build chamber at which the 3D object is to be fabricated;
an identification of a build material from which the 3D object is to be fabricated;
a date and/or time at which the 3D object is to be fabricated; and/or
a predefined 3D fabrication system that is to fabricate the 3D object.

13. The method of claim 9, further comprising:
generating a code corresponding to the accessed fabrication information;
generating the defined label to include the code; and
outputting the code, wherein the code is to be used to determine the accessed fabrication information.

14. A system comprising:
fabrication components; and
a processor to:
access a print file including data describing a plurality of three-dimensional (3D) object models, the data to be used to fabricate 3D objects corresponding to the plurality of 3D object models and the data identifying properties of label placeholders on the plurality of 3D object models;
for each of the plurality of 3D object models,
access fabrication information pertaining to the 3D object, the fabrication information differing from the accessed fabrication information pertaining to other ones of the plurality of 3D objects;
generate a defined label based on the accessed fabrication information;
modify the print file to insert the defined label at the label placeholder; and
control the fabrication components to fabricate the plurality of 3D objects to have the respective defined labels using the modified print file.

15. The system of claim 14, wherein, for each of the plurality of 3D object models, the accessed fabrication information comprises:
a spatial position in a build chamber at which the 3D object to be fabricated from the 3D object model is to be fabricated;
an orientation in the build chamber at which the 3D object is to be fabricated;
a predefined build material from which the 3D object is to be fabricated;
a date and/or time at which the 3D object is to be fabricated; and/or
a code corresponding to a build operation of the 3D object.
